(19) United States
(12) Patent Application Publication
(10) Pub. No.: US 2014/0231477 A1
(43) Pub. Date: Aug. 21, 2014

(54) Toolbox with Vertical Drawer

(71) Applicant: James Perkins, Sudan, NM (US)

(72) Inventor: James Perkins, Sudan, NM (US)

(21) Appl. No.: 13/772,322

(22) Filed: Feb. 20, 2013

(51) Int. Cl. B60R 11/06

(52) U.S. Cl. CPC B60R 11/06
USPC 224/404

(57) ABSTRACT

An improved toolbox is disclosed. Said improved toolbox comprising a first toolbox selectively attaching to a truck. Said first toolbox having a body having a top, bottom, front, back, first side, a second side and a one or more openings. Said body attached to a portion of a truck. A one or more doors selectively covering said one or more openings in said body. A center rack selectively sliding into and out of said body through said one or more openings.

### BACKGROUND

This disclosure comprises a nonprovisional filing on the basis of U.S. Provisional Patent Application No. 12113345.

This disclosure relates generally to an improved toolbox with vertical drawer. Examples of toolboxes include U.S. Pat. Nos. 4,174,037, 4,967,944, 6,089,429, 7,159,917, and 7,726,719, and/or U.S. patent application Nos. 2009/0127305, 2011/0121045, and 2006/0219746.

None of the above inventions and patents, taken either singularly or in combination, is seen to describe the instant disclosure as claimed. Accordingly, said improved toolbox with vertical drawer would be advantageous.

### SUMMARY

An improved toolbox and method of use are disclosed. Said improved toolbox comprising a first toolbox selectively attaching to a truck. Said first toolbox having a body having a top, bottom, front, back, first side, a second side and a one or more openings. Said body attached to a portion of a truck. A one or more doors selectively covering said one or more openings in said body. A center rack selectively sliding into and out of said body through said one or more openings.

Said method of using an improved toolbox comprising: attaching one or more toolboxes to a truck; selectively covering a one or more openings in a body of said one or more toolboxes; selectively sliding a center rack of said one or more toolboxes into and out of said body through said one or more openings. Said one or more toolboxes comprise a first toolbox. Said first toolbox having a body having a top, bottom, front, back, first side, a second side and a one or more openings. Said body attached to a portion of said truck.

### BRIEF DESCRIPTION OF THE DRAWINGS

FIGS. 1A, 1B, and 1C illustrate a perspective overview, an elevated rear view, and an elevated top view of a toolbox 100 on a flatbed truck 102.

FIGS. 2A and 2B illustrate a perspective rear view and a perspective overview of said toolbox on said flatbed truck.

FIGS. 2C and 2D illustrate perspective rear view and a perspective overview of said toolbox.

FIGS. 3A, 3B, 3C, and 3D illustrate an elevated top view, an elevated first side view, an elevated front view, and an elevated bottom view of a closed configuration of said toolbox.

FIGS. 4A, 4B and 4C illustrate an elevated first side view, an elevated front view, and a perspective first side overview.

FIGS. 4D and 4E illustrate a detailed front elevated view of said first door with said first door open and closed, respectively.

FIGS. 5A, 5B, and 5C illustrate a perspective overview, an elevated front view, and an elevated back view of said center rack.

FIGS. 6A and 6B illustrate an elevated top view of said track (isolated) and said track with said center rack, respectively.

FIG. 6C illustrates a perspective lower view of said toolbox.

FIGS. 7A and 7B illustrate perspective overviews of said first latch assembly and said second latch assembly.

FIGS. 8A, 8B, and 8C illustrate a perspective overview, an elevated rear view, and an elevated top view of said toolbox on a pickup truck.

FIGS. 9A, 9B and 9C illustrate a perspective overview, an elevated back view, and an elevated top view of said flatbed truck with a toolbox.

FIG. 10 illustrates a perspective overview of said toolbox on said flatbed truck with said door and said door open.

FIG. 11 illustrates a perspective overview of said flatbed truck with said toolbox in an open configuration and said center rack slid out of said body.

FIGS. 12A and 12B illustrate a side rear perspective overview and a close up side rear perspective overview of said flatbed truck and a toolbox in an open configuration.

FIG. 13 illustrates a perspective overview of said pickup truck.

FIG. 14 illustrates a perspective overview of said flatbed truck with a plurality of toolboxes.

### DETAILED DESCRIPTION

Described herein is an improved toolbox with vertical drawer. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

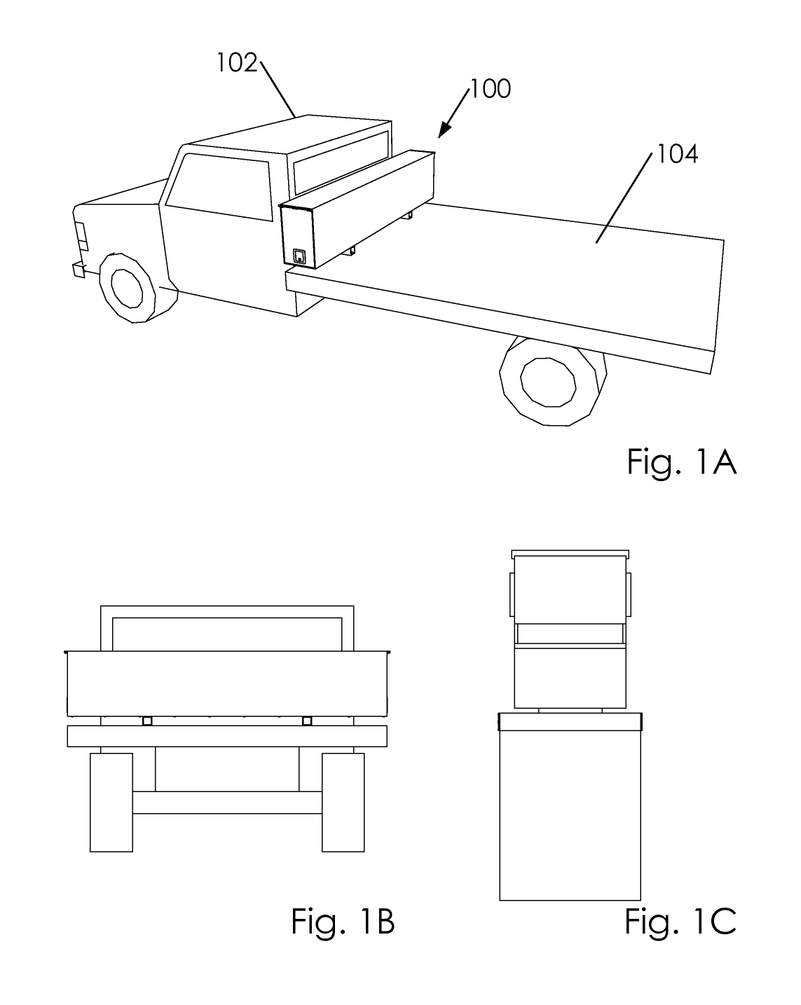

FIGS. 1A, 1B, and 1C illustrate a perspective overview, an elevated rear view, and an elevated top view of a toolbox 100 on a flatbed truck 102. In one embodiment, said flatbed truck 102 can comprise of a flatbed 104. In one embodiment, users of said flatbed truck 102 can have trouble storing objects and are unable to attach a toolbox to said flatbed 104 because commercially available toolboxes are not designed for use with trucks not having a traditional bed with rails and a tailgate. Accordingly, in one embodiment, said toolbox 100 can comprise one or more features for use with said flatbed 104. As shown and described, said flatbed truck 102 can comprise any vehicle to which said toolbox 100 (or variations thereon) can be attached.

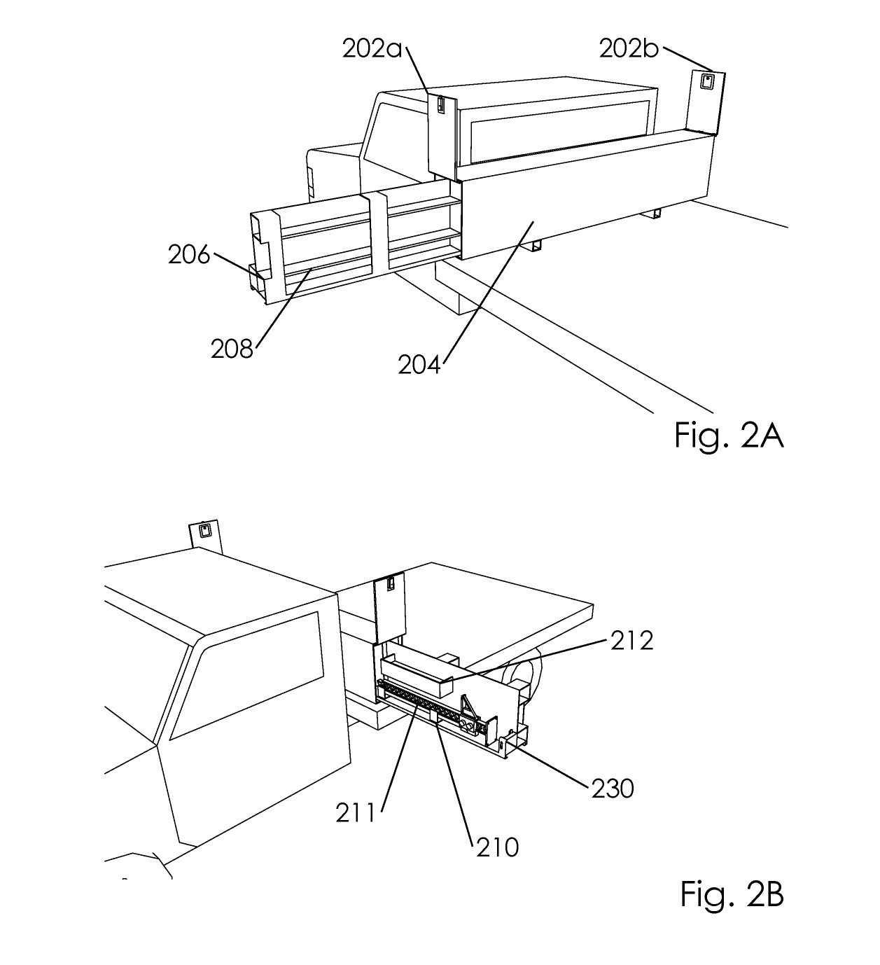

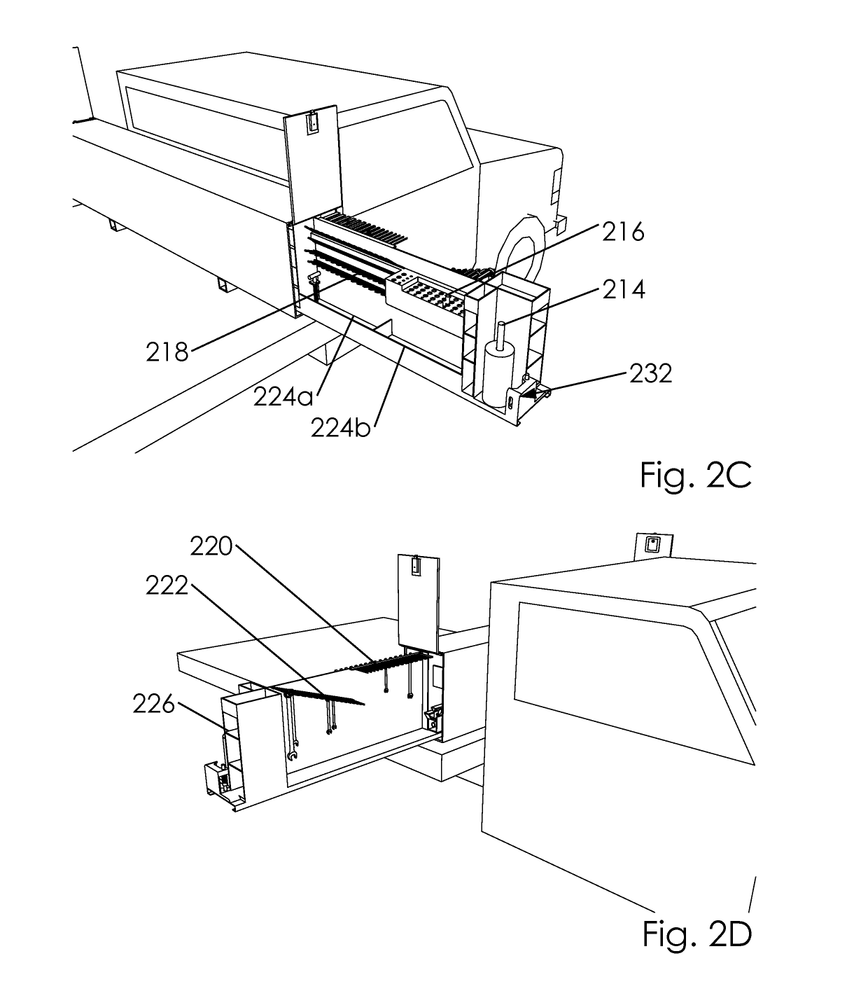

FIGS. 2A and 2B illustrate a perspective rear view and a perspective overview of said toolbox 100 on said flatbed truck 102. In one embodiment, said toolbox 100 can comprise of a one or more doors (comprising a first door 202a and a second door 202b), a body 204, and a center rack 206. In one embodiment, said center rack 206 can comprise of a one or more shelves (comprising a first shelf 208 and a second shelf 212), a jack holder 210 and a one or more latching assemblies. In one embodiment, said one or more latching assemblies can comprise a first latching assembly 230. In one embodiment, said first latching assembly 230 can selectively hold said center rack 206 within said body 204. In one embodiment, said jack holder 210 can hold a jack 211 (which can be of a hi-lift jack type).

FIGS. 2C and 2D illustrate perspective rear view and a perspective overview of said toolbox 100. In one embodiment, said toolbox 100 can comprise of a towel rack 214, a slot tool rack 216, a first hanging tool rack 218, a second hanging tool rack 220, a third hanging tool rack 222, a tray 224a, a tray 224b, a one or more shelves 226 and a second latch assembly 232.

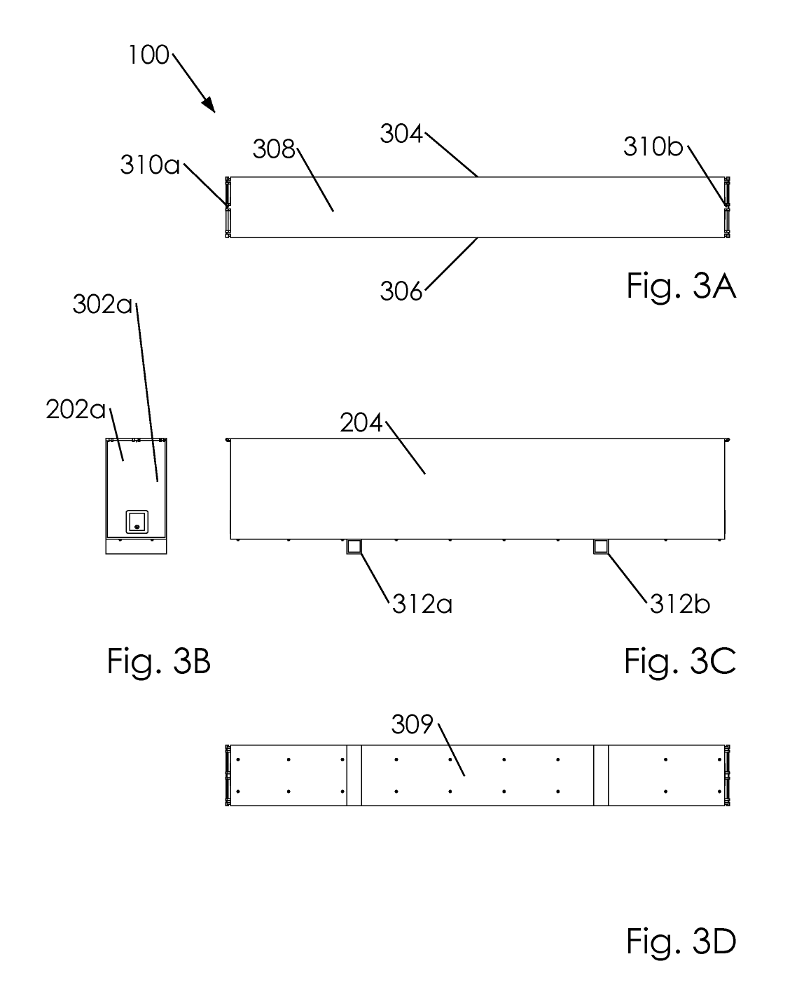

FIGS. 3A, 3B, 3C, and 3D illustrate an elevated top view, an elevated first side view, an elevated front view, and an elevated bottom view of a closed configuration 300 of said toolbox 100. In one embodiment, said closed configuration 300 of said toolbox 100 can comprise handle 302a, a front 304, a back 306, a top 308, a bottom 309, a first side 310a, a second side 310b, and a one or more mounting bars (comprising a mounting bar 312a and a mounting bar 312b). Said one or more mounting bars capable of attaching said body 204 to said flatbed truck 102.

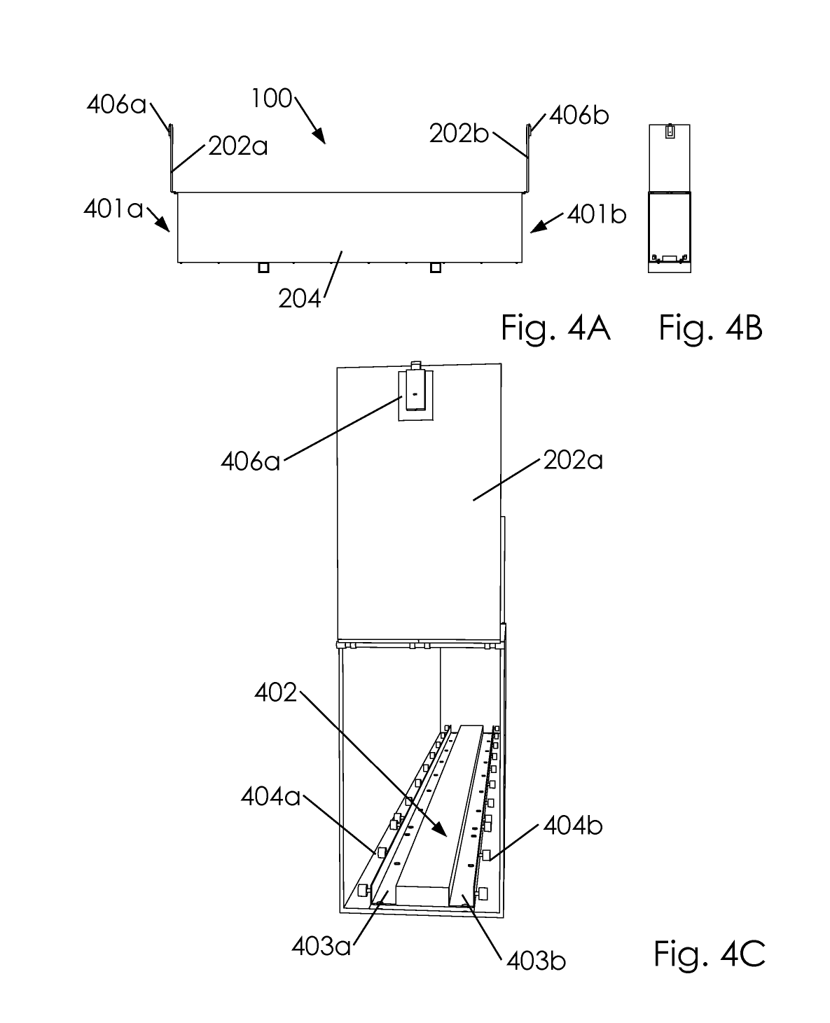

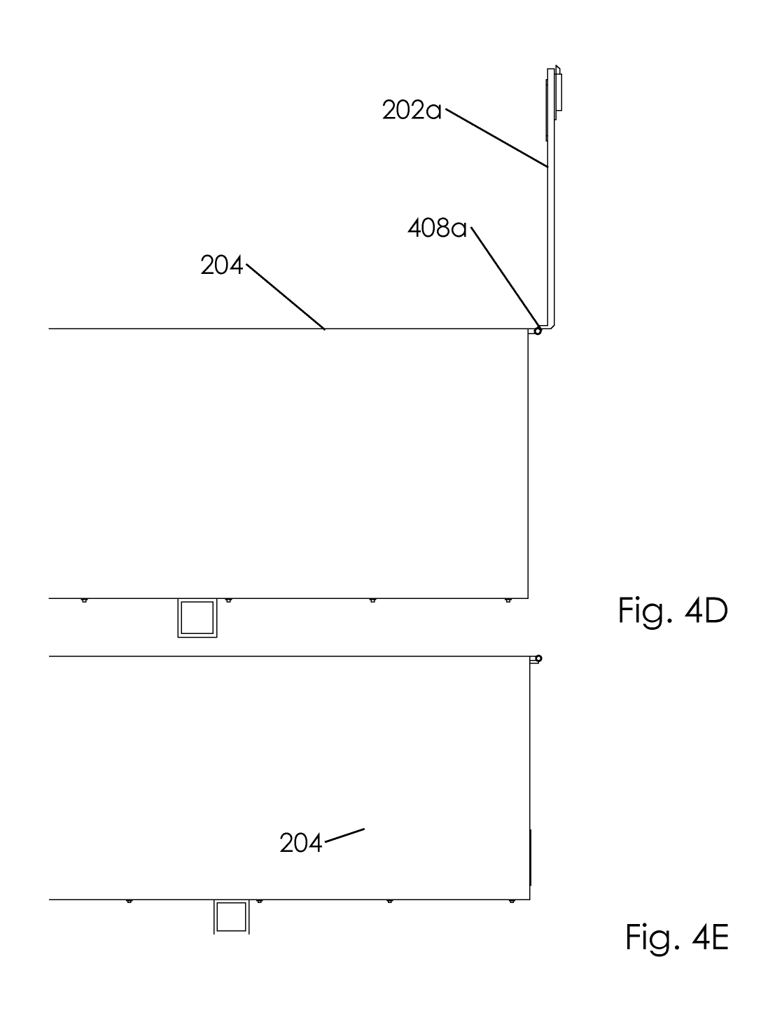

FIGS. 4A, 4B and 4C illustrate an elevated first side view, an elevated front view, and a perspective first side overview. In one embodiment, said toolbox 100 can comprise of a one or more openings (which can comprise a first opening 401a and a second opening 401b); wherein, said one or more doors can selectively cover said one or more openings. For example, in one embodiment, said first door 202a can selectively cover said first opening 401 a and said second door 202b can selectively cover said second opening 401b. In one embodiment, said body 204 can comprise a rectangular shape comprising said one or more openings at said first side 310a and said second side 310b. In one embodiment, said center rack 206 can slide in and out of said body 204 on a track 402. In one embodiment, said track 402 can attach to said bottom 309 within said body 204. In one embodiment, said track 402 can comprise a one or more tracks and a plurality of wheels. In one embodiment, said one or more tracks can comprise a first track 403a and a second track 403b. In one embodiment, said plurality of wheels can comprise a first wheel 404a and a second wheel 404b, as well as many others as illustrated. In one embodiment, said center rack 206 can slide along on said plurality of wheels and can be held along a path by said one or more tracks, as is known in the art and illustrated. In one embodiment, said track 402 can be bolted into said body 204. In one embodiment, said one or more doors can comprise a one or more latches. In one embodiment, said one or more latches can comprise a first latch 406a on said first door 202a and a second latch 406b on said second door 202b. In one embodiment, said one or more latches can comprise a locking mechanism for securing a contents of said toolbox 100.

FIGS. 4D and 4E illustrate a detailed front elevated view of said first door 202a with said first door 202a open and closed, respectively. In one embodiment, said one or more doors can be flush with said body 204 when closed, as shown, described and known in the art. In one embodiment, said one or more doors can rotate on a one or more hinges. In one embodiment, said one or more hinges can comprise a first hinge 408a (illustrated here) and a second hinge (not illustrated here). In one embodiment, rotating said one or more doors up on said one or more hinges can selectively open said one or more openings of said body 204 and rotating said one or more doors down on said one or more hinges can close said one or more openings of said body 204.

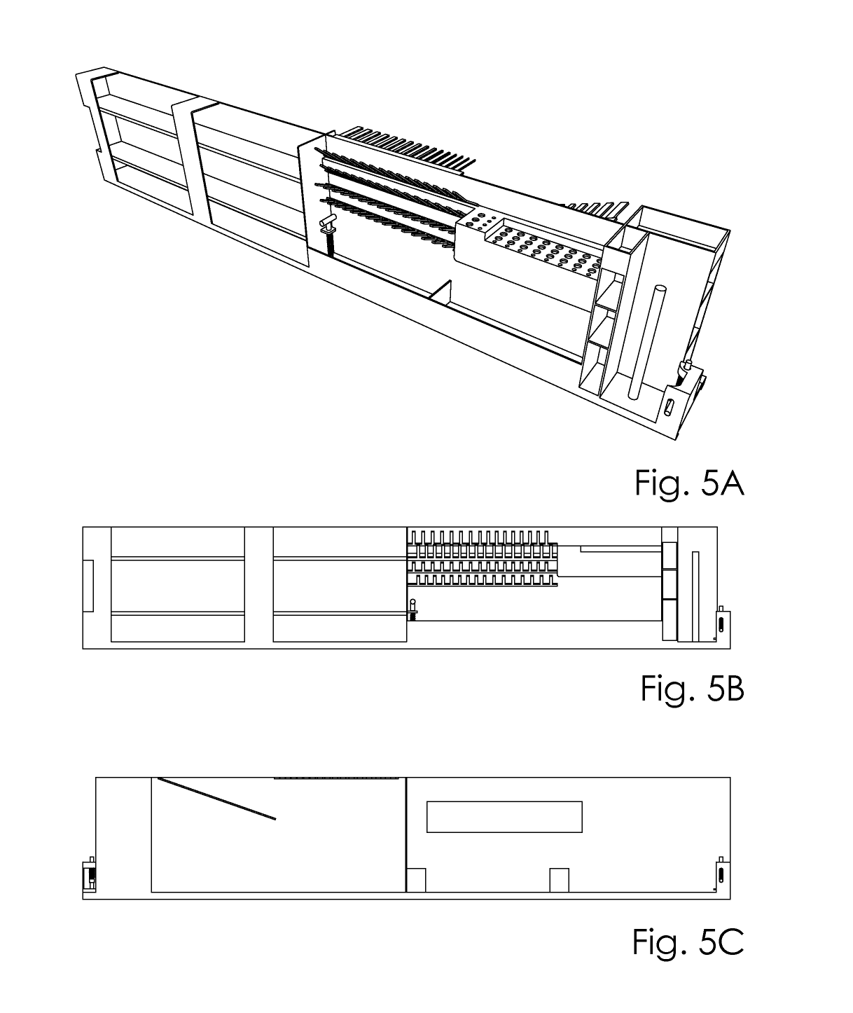

FIGS. 5A, 5B, and 5C illustrate a perspective overview, an elevated front view, and an elevated back view of said center rack 206.

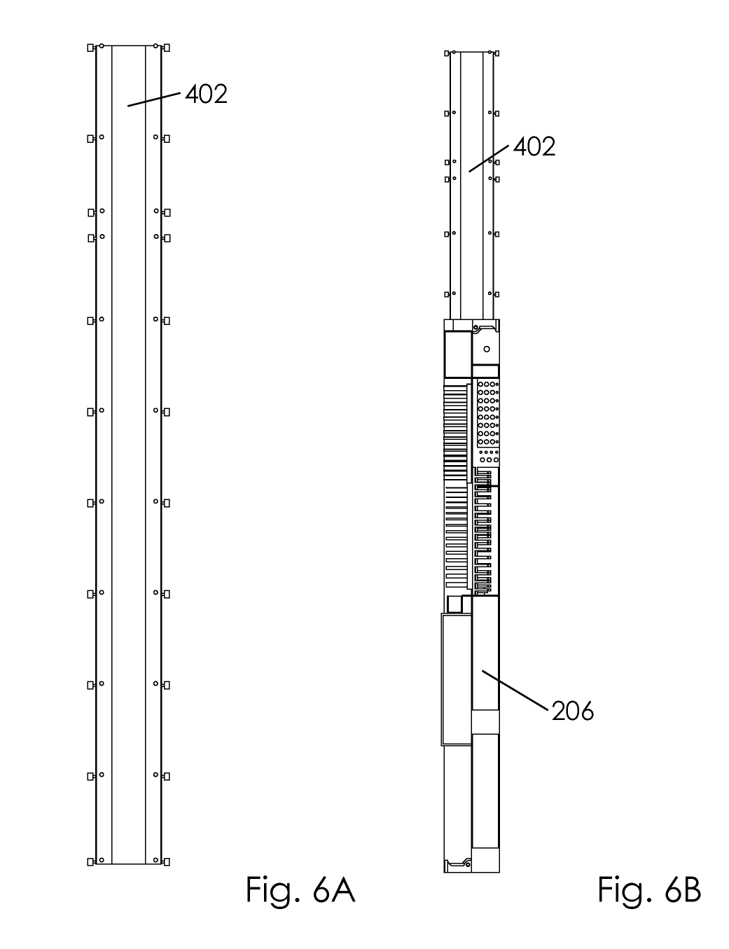

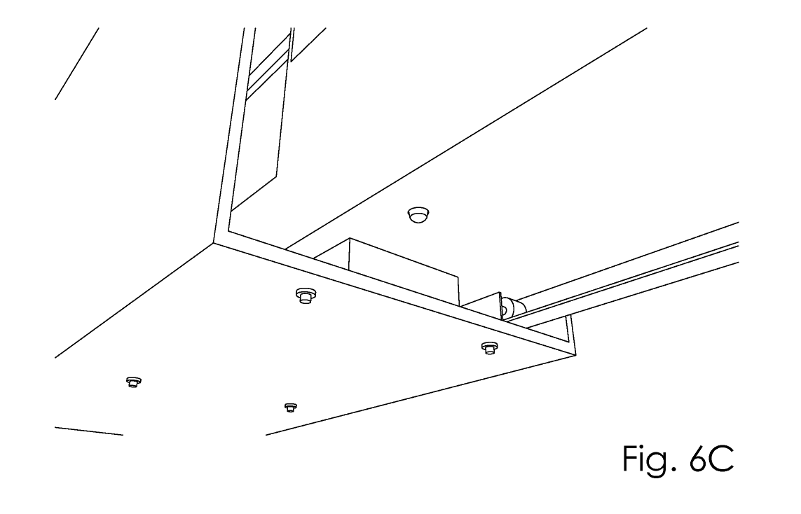

FIGS. 6A and 6B illustrate an elevated top view of said track 402 (isolated) and said track 402 with said center rack 206, respectively. In one embodiment, said track 402 can be removed from said body 204 for maintenance and/or replacement. In one embodiment, said center rack 206 can likewise be removed from said body 204 for similar reasons. Also, said center rack 206 can be selectively replaced with other embodiments of said center rack 206 as will be described below. In one embodiment, a method of using said toolbox 100 can comprise replacing said center rack 206 with an alternate center rack.

FIG. 6C illustrates a perspective lower view of said toolbox 100. In one embodiment, said center rack 206 can slide along on said plurality of wheels, as shown and described.

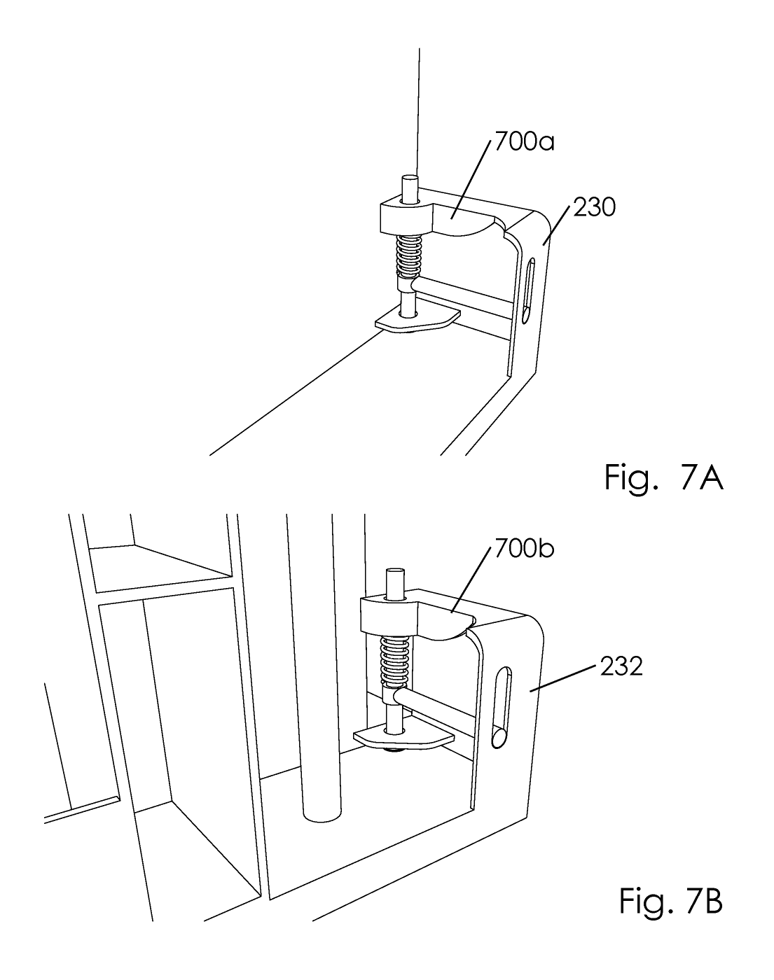

FIGS. 7A and 7B illustrate perspective overviews of said first latch assembly 230 and said second latch assembly 232. In one embodiment, said first latching assembly 230 can comprise a first lever 700a. In one embodiment, said second latching assembly 232 can comprise a second lever 700b. In one embodiment, said first latching assembly 230 can selectively lock said center rack 206 within said body 204.

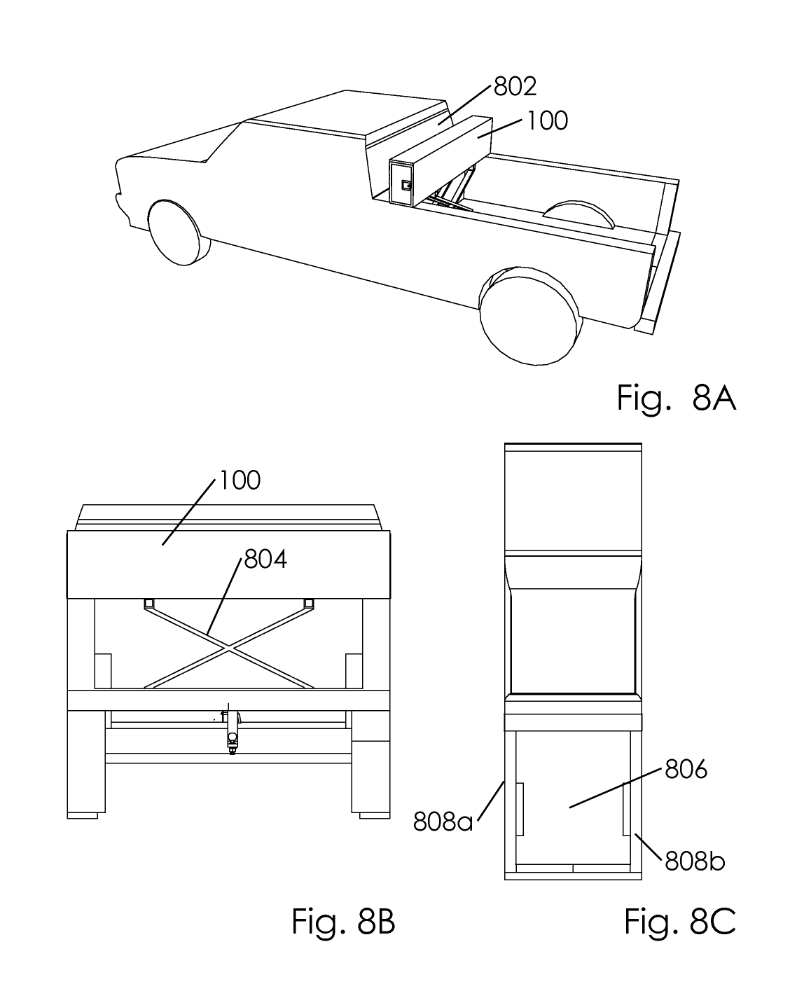

FIGS. 8A, 8B, and 8C illustrate a perspective overview, an elevated rear view, and an elevated top view of said toolbox 100 on a pickup truck 802. In one embodiment, said third toolbox 800 can be supported by a support 804. In one embodiment, said pickup truck 802 can comprise a traditional truck having a bed 806 and two side rails (comprising a first rail 808a and a second rail 808b). In one embodiment, said toolbox 100 can attach to said pickup truck 802 by attaching to said support 804 and said two side rails.

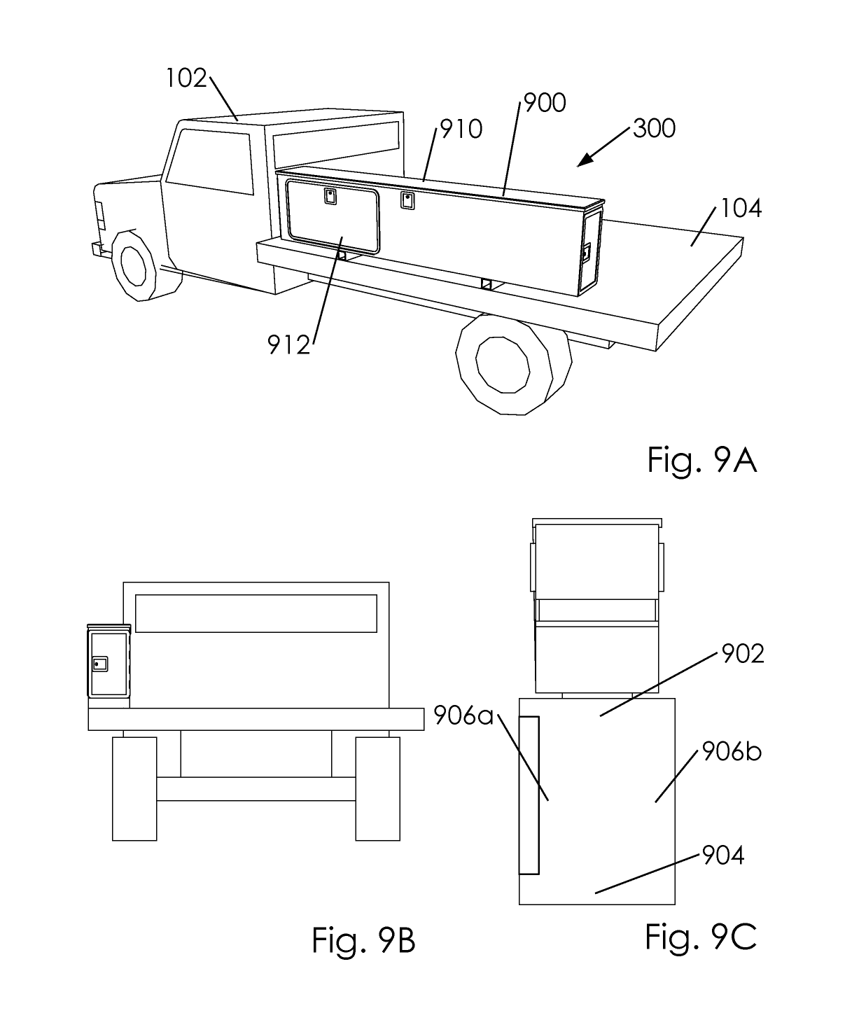

FIGS. 9A, 9B and 9C illustrate a perspective overview, an elevated back view, and an elevated top view of said flatbed truck 102 with a toolbox 900. In one embodiment, said flatbed truck 102 can comprise a forward portion 902, a rear portion 904, a first side portion 906a and a second side portion 906b. In one embodiment, said toolbox 900 can comprise a similar design to said toolbox 100; however, said toolbox 900 can comprise a door 910 in a top portion of said toolbox 900 and a door 912 in a front portion of said toolbox 900, as shown and described.

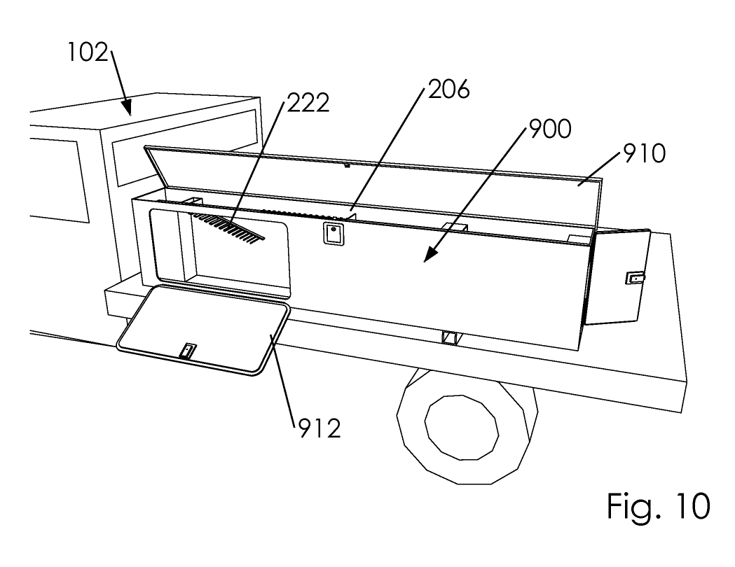

FIG. 10 illustrates a perspective overview of said toolbox 900 on said flatbed truck 102 with said door 910 and said door 912 open. In one embodiment, said toolbox 900 can hold said center rack 206 in a similar way as said toolbox 100. In one embodiment, a top portion of said center rack 206 can be accessed through said 910 and a side portion of said center rack 206 can be accessed through said door 912. Here, said toolbox 900 can comprise a first opening in said top portion of said toolbox 900, a second opening in a front portion of said toolbox 900 and a third opening in a second side portion of said toolbox 900.

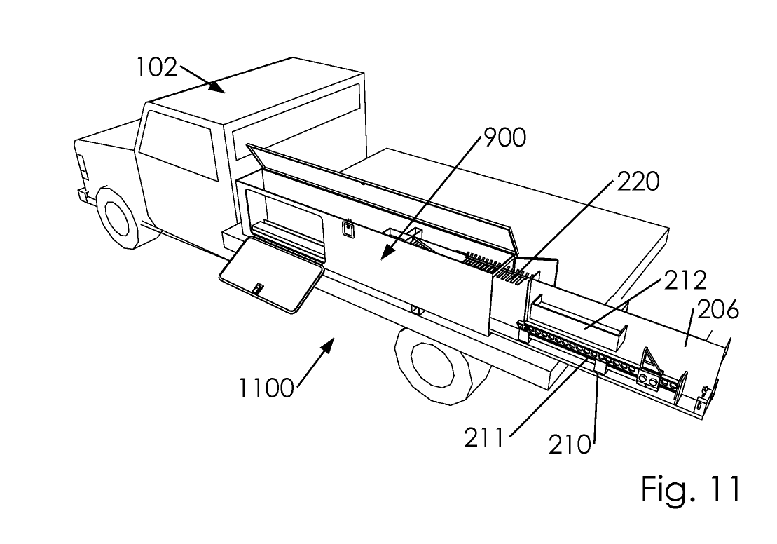

FIG. 11 illustrates a perspective overview of said flatbed truck 102 with said toolbox 900 in an open configuration and said center rack 206 slid out of said body 204. In one embodiment, said toolbox 900 can comprise said jack holder 210, said jack 211, said second shelf 212, and said second hanging tool rack 220. In one embodiment, said center rack 206 can slide out of said toolbox 900 toward a back portion of said flatbed truck 102.

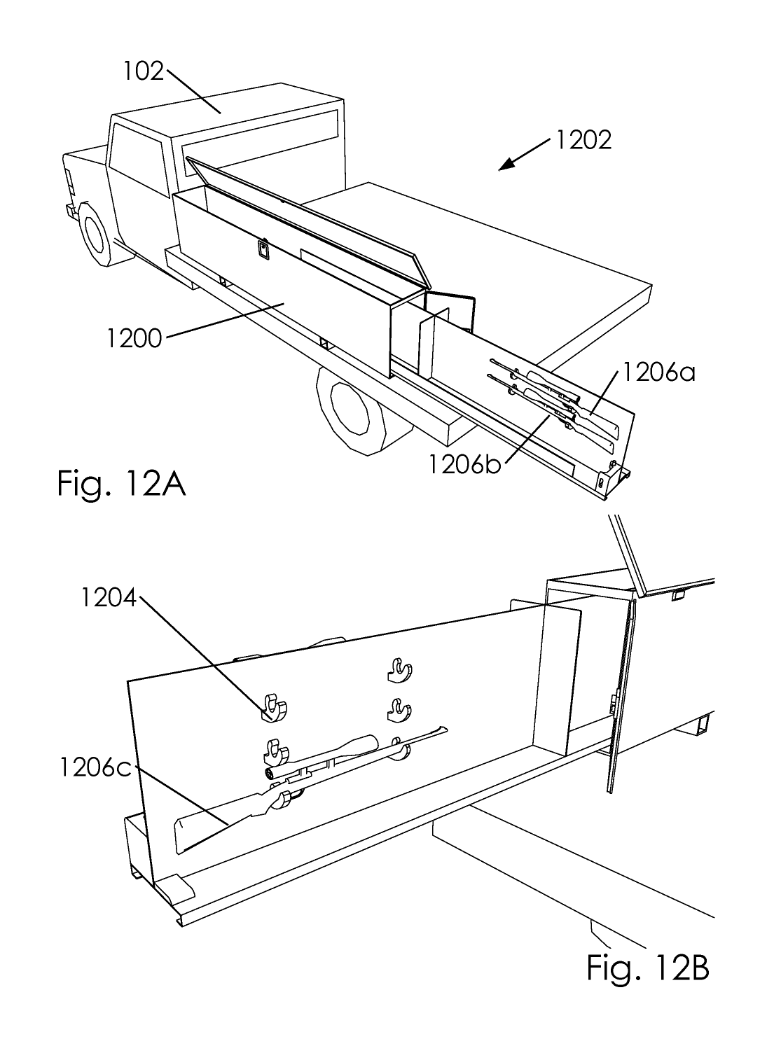

FIGS. 12A and 12B illustrate a side rear perspective overview and a close up side rear perspective overview of said flatbed truck 102 and a toolbox 1200 in an open configuration 1202. In one embodiment, said toolbox 1200 can comprise a gun rack 1204 capable of holding a one or more guns (such as a first gun 1206a, a second gun 1206b and a third gun 1206c). In one embodiment, said one or more guns can be locked within said toolbox 1200. In one embodiment, said toolbox 1200 can comprise a similar design to said toolbox 900 and said toolbox 100 with the adaptation of having said gun rack 1204.

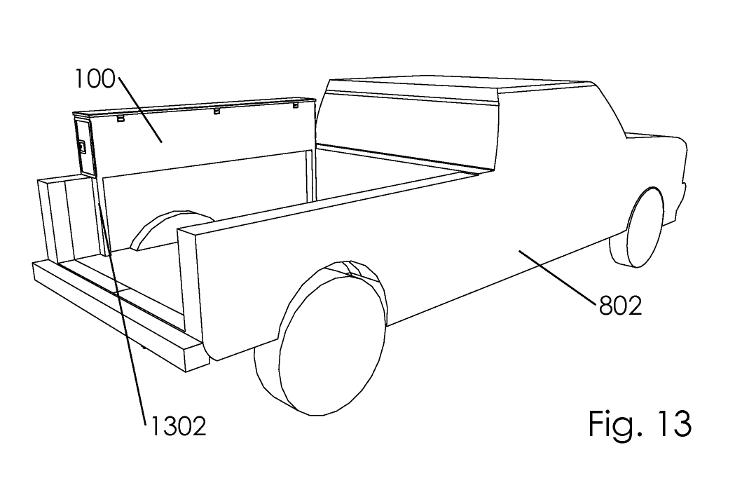

FIG. 13 illustrates a perspective overview of said pickup truck 802. In one embodiment, said pickup truck 802 can comprise said toolbox 100 having a one or more legs 1302.

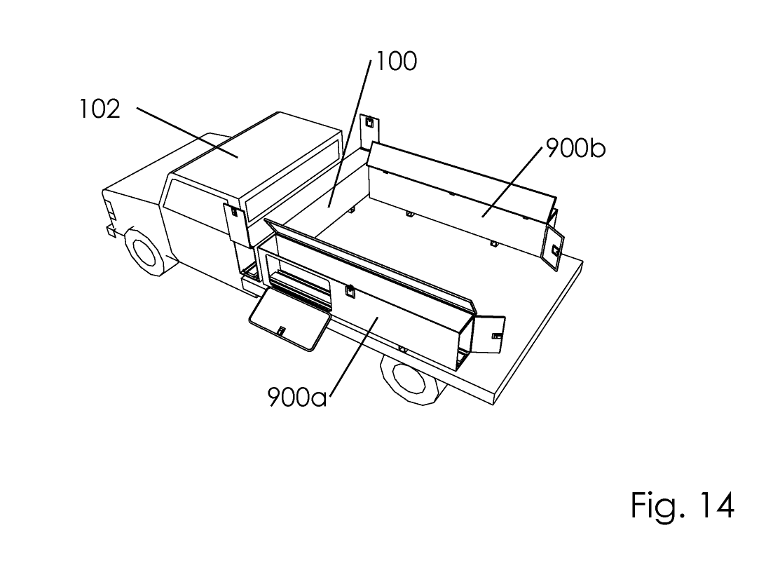

FIG. 14 illustrates a perspective overview of said flatbed truck 102 with a plurality of toolboxes. In one embodiment, said plurality of toolboxes can comprise said toolbox 100, a toolbox 900a and a toolbox 900b. In one embodiment, said toolbox 900a and said toolbox 900b can be substantially identical with said toolbox 900. In one embodiment, said plurality of toolboxes can create a “U” shape mimicking that of said bed 804 of said pickup truck 802; wherein, said toolbox 900a mimics said first rail 808a and said toolbox 900b mimics a second rail 808b.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An improved toolbox comprising:
a first toolbox selectively attaching to a truck;
said first toolbox having a body having a top, bottom, front, back, first side, a second side and a one or more openings;
said body attached to a portion of a truck;
a one or more doors selectively covering said one or more openings in said body; and
a center rack selectively sliding into and out of said body through said one or more openings.
said body comprises a rectangular container.
said one or more openings comprise a first opening and a second opening;
said first side of said body comprises said first opening; and
said second side of said body comprises said second opening.
said one or more openings comprise a first opening, a second opening and a third opening;
said top of said body comprises said first opening;
said front of said body comprises said second opening; and
said second side of said body comprises said second opening.
said center rack comprises a one or more shelves.

2. An improved toolbox comprising:
a first toolbox selectively attaching to a truck;
said first toolbox having a body having a top, bottom, front, back, first side, a second side and a one or more openings;
said body attached to a portion of a truck;
a one or more doors selectively covering said one or more openings in said body; and
a center rack selectively sliding into and out of said body through said one or more openings.

3. The improved toolbox of claim 2 wherein,
said body comprises a rectangular container.

4. The improved toolbox of claim 2 wherein,
said one or more openings comprise a first opening and a second opening;
said first side of said body comprises said first opening; and
said second side of said body comprises said second opening.

5. The improved toolbox of claim 2 wherein,
said one or more openings comprise a first opening, a second opening and a third opening;
said top of said body comprises said first opening;
said front of said body comprises said second opening; and
said second side of said body comprises said second opening.

6. The improved toolbox of claim 2 wherein,
said center rack comprises a one or more shelves.

7. The improved toolbox of claim 2 wherein,
said center rack comprises a jack holder capable of holding a jack.

8. The improved toolbox of claim 2 wherein,
said center rack comprises a gun rack capable of holding a one or more guns.

9. The improved toolbox of claim 2 wherein,
said center rack comprises a one or more latching assemblies capable of selectively holding said center rack within said body.

10. The improved toolbox of claim 2 further comprising a one or more mounting bars capable of attaching said body of said first toolbox to said truck.

11. The improved toolbox of claim 2 wherein
said truck comprises a flatbed truck;
said flatbed comprises a forward portion, a rear portion and a two side portions (comprising a first side portion and a second side portion); and
said first toolbox attaches to a flatbed of said truck.

12. The improved toolbox of claim 11 further comprising a second toolbox and a third toolbox; wherein,
said first toolbox attaches to said forward portion of said flatbed;
said second toolbox attaches to said first side portion of said flatbed; and
said third toolbox attaches to said second side portion of said flatbed.

13. The improved toolbox of claim 11 further comprising a second toolbox and a third toolbox; wherein,
said first toolbox attaches to said forward portion of said flatbed;
said one or more openings are accessible from said two side portions of said flatbed.

14. The improved toolbox of claim 11 further comprising a second toolbox and a third toolbox; wherein,
said first toolbox attaches at one of said two side portions; and
said one or more openings are accessible from said rear portion of said flatbed.

15. The improved toolbox of claim 2 wherein
said truck comprises a bed and two side rails; and,
said first toolbox attaches to said two side rails and a support within said bed of said truck.

16. A method of using an improved toolbox comprising:
attaching one or more toolboxes to a truck;
selectively covering a one or more openings in a body of said one or more toolboxes; and,
selectively sliding a center rack of said one or more toolboxes into and out of said body through said one or more openings; wherein,
said one or more toolboxes comprise a first toolbox;
said first toolbox having a body having a top, bottom, front, back, first side, a second side and a one or more openings; and
said body attached to a portion of said truck.

17. The method of using an improved toolbox of claim 16 further comprising:
rotating said one or more doors up on said one or more hinges to selectively open said one or more openings in said body; and
rotating said one or more doors down on said one or more hinges to selectively close said one or more openings in said body.

18. The method of using an improved toolbox of claim 16 further comprising:
selectively replacing said center rack by removing said center rack and attaching an alternate center rack within said body of said first toolbox.

19. The method of using an improved toolbox of claim 16 further comprising:
sliding said center rack on a plurality of wheels on said track.

20. The method of using an improved toolbox of claim 16 further comprising:
selectively locking said center rack within said body of said first toolbox.

21. The method of using an improved toolbox of claim 16 further comprising:
locking said first toolbox to secure a contents of said first toolbox.
